(19) United States
(12) Patent Application Publication
(10) Pub. No.: US 2017/0199404 A1
(43) Pub. Date: Jul. 13, 2017

(54) DISPLAY DEVICES AND THE ASSEMBLY METHODS THEREOF

(71) Applicant: Wuhan China Star Optoelectronics Technology Co., Ltd., Wuhan (CN)

(72) Inventors: Wu LI, Shenzhen (CN); Youzhong HUANG, Shenzhen (CN)

(73) Assignee: Wuhan China Star Optoelectronics Technology Co., Ltd., Wuhan (CN)

(21) Appl. No.: 15/169,791

(22) Filed: Jun. 1, 2016

(30) Foreign Application Priority Data
Jan. 8, 2016 (CN) 2016100127181

(51) Int. Cl. G02F 1/1333; F21V 8/00

(52) U.S. Cl. CPC G02F 1/1333; G02B 6/0051; G02B 6/0055; G02B 6/0053; G02B 6/0088; G02B 6/0091; G02F 2202/28

(57) ABSTRACT

The present disclosure relates to a display device and the assembly method thereof. The method includes bonding the backlight module and the display panel via the optical transparent glue, wherein the optical transparent glue is distributed on one surface of the backlight module and/or one surface of the display panel. The manufacturing process is simply such that the backlight surface may be effectively utilized, which contributes to the narrow border or borderless trend of the display device.

### BACKGROUND OF THE INVENTION

1. Field of the Invention

The present disclosure relates to display technology, and more particularly to an assembly method of display devices, and the display device assembled by the method.

2. Discussion of the Related Art

Backlit relates to the lighting component behind the display panel. Within liquid crystal display modules, the liquid crystal panel has to be radiated by light such that human eyes can see the patterns continuously displayed by the liquid crystal panel.

The liquid crystal panel relates to a flat panel. To display patterns in different locations on the liquid crystal panel, the difference between the light beams radiating on different locations of the liquid crystal panel cannot be too huge. That is, it is not applicable to arrange one or several light emitting diodes (LEDs) behind the liquid crystal panel. Instead, an surface that can uniformly emit the light beams is needed. To satisfy the requirement of the liquid crystal panel, the LED is adopted as the basic light source, and the light beams are converted to be the surface light source.

There are two assembly methods of backlit, wherein one is iron-frame clasping, and the other one is black-tape glue. These two methods relate to integrate the backlit and the liquid crystal panel. These solutions both occupy the borders of the backlit, which is generally above 0.5 mm. If the border is too narrow, the adhesive of the backlight assembly may not be enough, and thus may be easily detached.

The conventional backlit requiring the border greater than 0.5 mm cannot meet the borderless trend of current development of the display technology.

### SUMMARY

According to the present disclosure, the display device and the assembly method are capable of overcoming the above-mentioned problems.

In one aspect, an assembly method of display devices includes: bonding at least one backlight module and a liquid crystal panel via optical transparent glue, wherein the optical transparent glue is distributed on one surface of the backlight module and/or one surface of the display panel.

Wherein the step of bonding at least one backlight module and a liquid crystal panel via optical transparent glue further includes: providing a bonding mechanism for compressing the backlight module and the display panel together; arranging the display panel on a top late of the bonding mechanism; arranging the backlight module on a down plate of the bonding mechanism; distributing the optical transparent glue on one surface of the backlight module; and compressing the top late and the down plate such that the display panel is bonded with the optical transparent glue on the backlight module.

Wherein the step of bonding at least one backlight module and a liquid crystal panel via optical transparent glue further includes: providing a bonding mechanism for compressing the backlight module and the display panel together; arranging the display panel on a top late of the bonding mechanism; arranging the backlight module on a down plate of the bonding mechanism; distributing the optical transparent glue on one surface of the backlight module; and compressing the top late and the down plate such that the backlight module is bonded with the optical transparent glue on the display panel.

Wherein the step of bonding at least one backlight module and a liquid crystal panel via optical transparent glue further includes: adopting a dispensing method to distribute the optical transparent glue on one surface of the backlight module; arranging the display panel on the optical transparent glue to bond the display panel on the backlight module; distributing the optical transparent glue between the backlight module and the display panel via self-leveling, heat leveling, or pressure-leveling; and curing the optical transparent glue.

Wherein the step of bonding at least one backlight module and a liquid crystal panel via optical transparent glue further includes: coating the optical transparent glue on one surface of the backlight module; arranging the display panel on the optical transparent glue to bond the display panel on the backlight module so as to form the display device; and curing the optical transparent glue.

In another aspect, a display device includes: a backlight module, optical transparent glue, and a display panel, bonding surfaces of the backlight module and the display panel are bonded together via the optical transparent glue.

Wherein the optical transparent glue is the optical transparent glue in a solid or a liquid state.

Wherein a thickness of the optical transparent glue 20 is in a range between 20 and 100 μm.

Wherein the backlight module and the display panel are compressed by a wheel bonding mechanism or a bonding mechanism having a vacuum chamber.

Wherein the backlight module compresses a light source, a frame, and a reflective sheet, a light guiding plate, a diffuser and an enhancement film arranged on the frame in sequence, and wherein the light source is arranged on one side of the light guiding plate, and the optical transparent glue is distributed on a top surface of the enhancement film.

In view of the above, the backlight module is bonded with the display panel via the optical transparent glue, wherein the optical transparent glue is distributed on one surface of the backlight module and/or one surface of the display panel. The manufacturing process is simply such that the backlight surface may be effectively utilized, which contributes to the narrow border or borderless trend of the display device.

### BRIEF DESCRIPTION OF THE DRAWINGS

FIG. 1 is a cross-sectional view of the display device in accordance with one embodiment.

FIG. la is schematic view showing the backlight module of the display device of FIG. 1.

FIG. 2 is a schematic view showing the display device when being assembled.

FIG. 3 is a flowchart of the assembly method of display devices in accordance with one embodiment.

FIG. 4 a flowchart of the assembly method of display devices in accordance with another embodiment.

FIG. 5 a flowchart of the assembly method of display devices in accordance with another embodiment.

FIG. 6 a flowchart of the assembly method of display devices in accordance with another embodiment.

FIG. 7 a flowchart of the assembly method of display devices in accordance with another embodiment.

### DETAILED DESCRIPTION OF THE EMBODIMENTS

Embodiments of the invention will now be described more fully hereinafter with reference to the accompanying drawings, in which embodiments of the invention are shown.

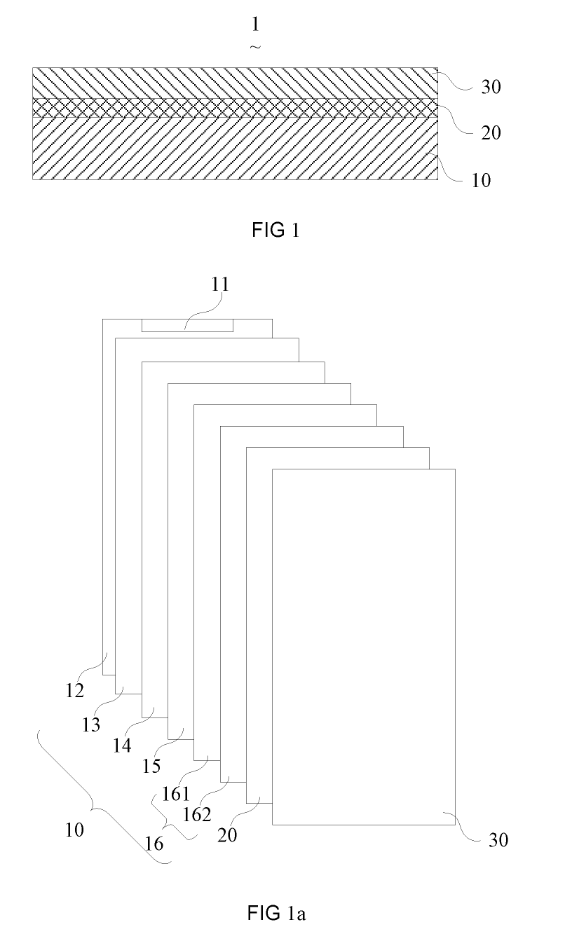

FIG. 1 is a cross-sectional view of the display device in accordance with one embodiment. A display device 1 includes a backlight module 10, optical transparent glue 20, and a display panel 30. Bonding surfaces of the bonding surfaces of the 10 and the display panel 30 are bonded together via the optical transparent glue 20, wherein the optical transparent glue 20 is distributed on the backlight module 10 and the display panel 30. In one embodiment, the optical transparent glue 20 may be configured on one surface of the backlight module or on one surface of the display panel 30. In another example, the optical transparent glue 20 may be configured on one surface of the backlight module and a rim of one surface of the display panel 30.

The optical transparent glue 20 may be optical transparent glue in a solid or a liquid state. A thickness of the optical transparent glue 20 is in a range between 20 and 100 μm.

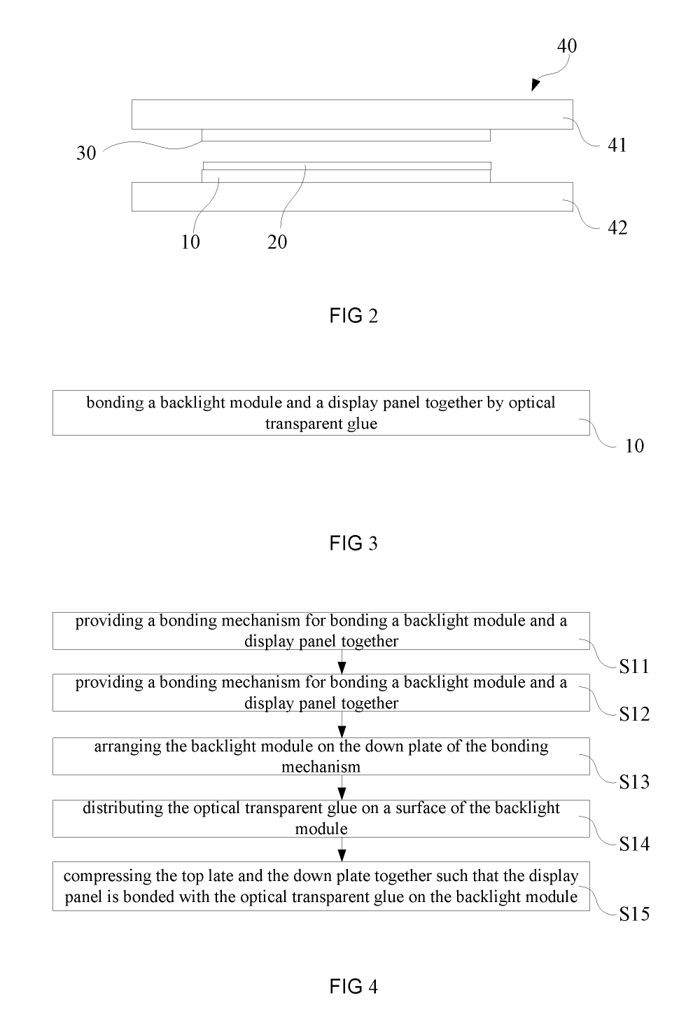

FIG. 2 is a schematic view showing the display device when being assembled. The backlight module 10 and the display panel 30 are bonded closely by a bonding mechanism 40. The bonding mechanism 40 may be a wheel bonding mechanism or a bonding mechanism having a vacuum chamber. The bonding mechanism 40 includes a top late 41 and a down plate 42. The display panel 30 is arranged on the top late 41 of the bonding mechanism 40, and the backlight module 10 is arranged on the down plate 42 of the bonding mechanism 40. The optical transparent glue 20 is distributed on a top surface of the backlight module 10, and the top late 41 and the down plate 42 are compressed to be together so as to bond the display panel 30 and the optical transparent glue 20 on the backlight module 10. In another example, the optical transparent glue 20 may be distributed on the display panel 30, and the optical transparent glue 20 and the backlight module 10 on the down plate 42 are bonded together.

FIG. la is schematic view showing the backlight module of the display device of FIG. 1. The backlight module 10 includes a light source 11, a frame 12, and a reflective sheet 13, a light guiding plate 14, a diffuser 15 and an enhancement film 16 arranged on the frame 12 in sequence. The light source 11 is arranged on one side of the light guiding plate 14. The enhancement film 16 includes a top enhancement film 161 and a down enhancement film 162. The optical transparent glue 20 is arranged on a top surface of the top enhancement film 161. When the display device 1 is turned on, light beams emitted by the light source 11 enter the light guiding plate 14, the diffuser 15, the top enhancement film 161, the down enhancement film 162, the optical transparent glue 20, and the display panel 30 in sequence. The light beams that have not entered the light guiding plate 14 are reflected by the reflective sheet 13 and then enter the light guiding plate 14.

FIG. 3 is a flowchart of the assembly method of display devices in accordance with one embodiment. The method includes the following steps.

In step S10, bonding a backlight module 10 and a display panel 30 together by optical transparent glue 20. In one embodiment, the optical transparent glue 20 may be distributed on one surface of the optical transparent glue 20, and the then the optical transparent glue 20 is bonded together with the display panel 30. In another example, the optical transparent glue 20 may be distributed on one surface of the display panel 30, and the optical transparent glue 20 is bonded together with the backlight module 10. In another example, the optical transparent glue 20 may be arranged on one surface of the backlight module and one surface of the display panel 30, and the backlight module 10 and the optical transparent glue 20 are bonded together.

It can be understood that the optical transparent glue 20 may be distributed on the whole surface of the backlight module or of the display panel 30. In another example, the optical transparent glue 20 may be distributed on one surface of the optical transparent glue 20 or a rim of the surface of the display panel 30. As the optical transparent glue 20 is transparent and the optical transparent glue 20 includes a bonding function, clips for clasping the rim of the backlight module 10 and the display panel 30 is not needed. As such, the whole surface of the backlight module 10 may be effectively utilized, which contributes to the narrow-border or borderless trend of the display device 1.

FIG. 4 a flowchart of the assembly method of display devices in accordance with another embodiment. The method includes the following steps.

In step S11, providing a bonding mechanism 40 for bonding a backlight module 10 and a display panel 30 together.

The bonding mechanism 40 may be a wheel bonding mechanism or a bonding mechanism having a vacuum chamber. The bonding mechanism 40 includes a top late 41 and a down plate 42. The top late 41 and the down plate 42 may stably absorb the backlight module 10 and the display panel 30 via the vacuum chamber.

In step S12, providing a bonding mechanism 40 for bonding a backlight module 10 and a display panel 30 together.

In step S13, arranging the backlight module 10 on the down plate 42 of the bonding mechanism 40.

The down plate 42 may fix the backlight module 10 by vacuum absorption. In another example, a plurality of adhesive nails corresponding to a rim of the backlight module 10 may be configured on the down plate 42 as long as the backlight module 10 is prevented from moving around.

In step S14, distributing the optical transparent glue 20 on a surface of the backlight module 10.

The optical transparent glue 20 may be distributed on a rim of the surface of the backlight module 10, or may be distributed on the whole surface of the backlight module 10.

It is to be noted that step S14 may be executed before the step S12. Preferably, the step S14 is executed after the step S13. When one surface of the backlight module 10 is configured with the optical transparent glue 20, the step S15 is executed. As such, the stickiness of the optical transparent glue 20 may be prevented from being lowered due to contacting with a great deal of dimension for a long time, which enhances the capability of the optical transparent glue 20.

In step S15, compressing the top late 41 and the down plate 42 together such that the display panel 30 is bonded with the optical transparent glue 20 on the backlight module 10.

When the bonding mechanism 40 is a wheel bonding mechanism, the top late 41 having the wheels engages with the down plate 42. The top late 41 rotates the display panel 30 so as to be compressed tightly on the backlight module 10. In addition, bubbles within the optical transparent glue 20 between the backlight module 10 and the display panel 30 may be forced out, which enhances the uniformity and the adhesive capability of the optical transparent glue 20.

It is to be noted that when the bonding mechanism 40 is the bonding mechanism configured with the vacuum chamber, the step S12 of absorbing the display panel 30 by the light guiding plate 14 is not needed. Instead, after the step S14, the display panel 30 is arranged on the backlight module 10 configured with the optical transparent glue 20, and the top late 41 and the down plate 42 are compressed together. At this moment, the top late 41 and the down plate 42 form the vacuum chamber. The bubbles within the optical transparent glue 20 between the backlight module 10 and the display panel 30 are forced out by continuous vacuum pumping with respect to the vacuum chamber. In this way, the uniformity and the adhesive capability of the optical transparent glue 20 may be enhanced.

FIG. 5 a flowchart of the assembly method of display devices in accordance with another embodiment. The difference between this embodiment and the above embodiment resides in the distributed location of the optical transparent glue 20. Specifically, the method includes the flowing steps.

In step S21, providing a bonding mechanism 40 for bonding a backlight module 10 and a display panel 30 together.

In step S22, arranging the display panel 30 on the top late 41 of the bonding mechanism 40.

In step S23, arranging the display panel 30 on the down plate 42 of the bonding mechanism 40.

In step S24, distributing the optical transparent glue 20 on a surface of the display panel 30.

In step S25, compressing the top late 41 and the down plate 42 together such that the display panel 30 is bonded with the optical transparent glue 20 on the display panel 30

It is to be noted that the optical transparent glue 20 may be Optically Clear Adhesive (OCA), which is characterized by attributes such as high stickiness, high peel strength, anti-high temperature/humidity, and anti-ultraviolet rays, endurable, non-yellowing type, non-layering or degradation, which may correct the reflection loss. In addition, the transmittance rate is above 99%, the reflective rate is about 1.48, and haze ratio is smaller than 1%.

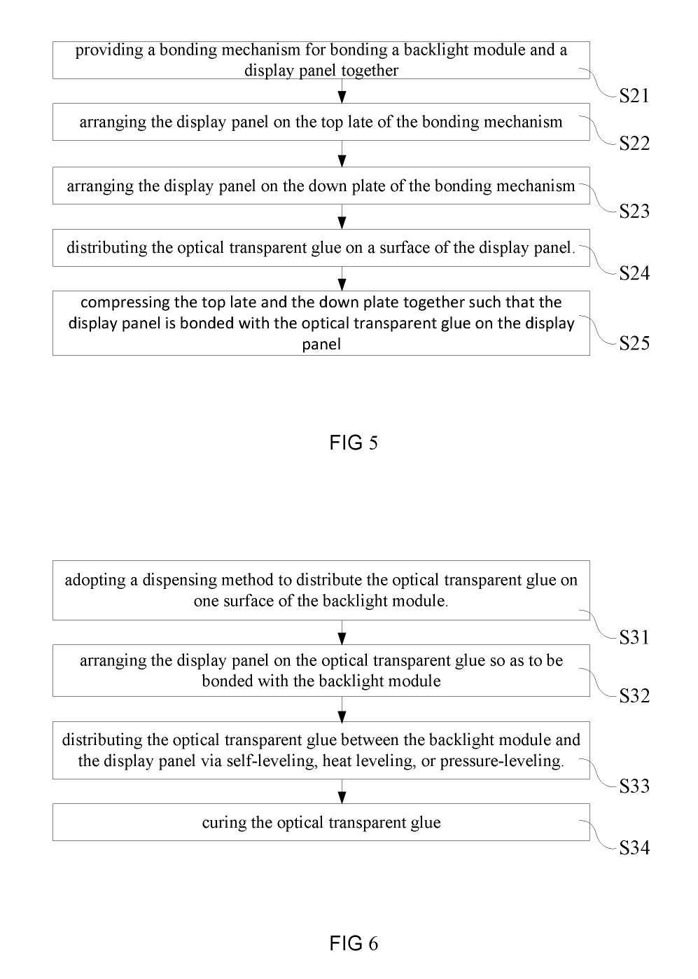

FIG. 6 a flowchart of the assembly method of display devices in accordance with another embodiment. The method includes the following steps.

In step S31, adopting a dispensing method to distribute the optical transparent glue 20 on one surface of the backlight module 10.

In one example, the optical transparent glue 20 may be Optical Clear Resin (OCR). During the bonding process, the OCR is liquid and thus may adapt to materials of concave and convex state. Such material can avoid the bubbles because that it is difficult for the air to enter in. In addition, only one-time bonding is executed, and the vacuum is not needed. Furthermore, the optical transparent glue 20 may be re-build in a pre-cure state.

In other embodiment, the dispensing method may be adopted to distribute the optical transparent glue 20 on one surface of the display panel 30, and the optical transparent glue 20 is bonded with the backlight module 10. The distribution location of the optical transparent glue 20 may be configured in accordance with real scenario.

It is to be noted that, in other embodiments, the optical transparent glue 20 may be distributed on one surface of the backlight module 10 via self-leveling, heat-leveling, or pressure-leveling, and then the process goes to step S32. At this moment, the step S33 has not to be executed.

In step S32, the display panel 30 is arranged on the optical transparent glue 20 so as to be bonded with the backlight module 10.

In step S33, distributing the optical transparent glue 20 between the backlight module 10 and the display panel 30 via self-leveling, heat leveling, or pressure-leveling.

As the optical transparent glue 20 is formed on the backlight module 10 via the dispensing method, which may result in non-uniformity. Thus, it is necessary to enhance the uniformity of the optical transparent glue 20 in this embodiment. The self-leveling relates to the scenario wherein the liquid flows naturally, that is, without any pressure, and finally reaches the leveling state. The pressure-leveling relates to apply external forces to accelerate the leveling of the liquid. Heat-leveling relates to heating the optical transparent glue 20 between the backlight module 10 and the display panel 30 to accelerate the leveling of the liquid. The above leveling methods contribute to the uniformity and flatness of the optical transparent glue 20.

In step S34, curing the optical transparent glue 20.

Wherein the optical transparent glue 20 may be cured by thermosetting or UV setting.

Similarly, the optical transparent glue 20 may be distributed on one surface of the backlight module or the whole surface of the display panel 30. In another example, the optical transparent glue 20 may be distributed on one surface of the backlight module or a rim of one surface of the display panel 30.

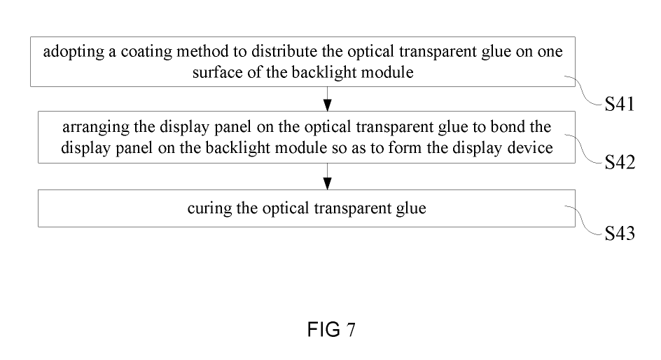

FIG. 7 a flowchart of the assembly method of display devices in accordance with another embodiment. The method includes the following steps.

In step S41, adopting a coating method to distribute the optical transparent glue 20 on one surface of the backlight module 10.

In this embodiment, the optical transparent glue 20 may be the OCR, wherein a coating machine is adopted to coat uniformly the optical transparent glue 20 on one surface of the backlight module 10. The optical transparent glue 20 may be coated on one surface of the backlight module 10 or the whole surface of the display panel 30. In another example, the optical transparent glue 20 may be coated on one surface of the backlight module 10 or a rim of one surface of the display panel 30.

In step S42, arranging the display panel 30 on the optical transparent glue 20 to bond the display panel 30 on the backlight module 10 so as to form the display device.

In step S43, curing the optical transparent glue 20, wherein the optical transparent glue 20 may be cured by heat setting or UV setting.

In view of the above, the backlight module 10 is bonded with the display panel 30 via the optical transparent glue 20, wherein the optical transparent glue 20 is distributed on one surface of the backlight module and/or one surface of the display panel 30. The manufacturing process is simply such that the backlight surface may be effectively utilized, which contributes to the narrow border or borderless trend of the display device 1.

It is to be noted that the terms such as, “first”, “second”, “top”, “down”, “left” and “right” only relate to descriptions with reference to the drawings. In real scenario, the above terms are interchangeable.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An assembly method of display devices, comprising:
bonding at least one backlight module and a liquid crystal panel via optical transparent glue, wherein the optical transparent glue is distributed on one surface of the backlight module and/or one surface of the display panel.

2. The assembly method as claimed in claim 1, wherein the step of bonding at least one backlight module and a liquid crystal panel via optical transparent glue further comprises:
providing a bonding mechanism for compressing the backlight module and the display panel together;
arranging the display panel on a top late of the bonding mechanism;
arranging the backlight module on a down plate of the bonding mechanism;
distributing the optical transparent glue on one surface of the backlight module; and
compressing the top late and the down plate such that the display panel is bonded with the optical transparent glue on the backlight module.

3. The assembly method as claimed in claim 1, wherein the step of bonding at least one backlight module and a liquid crystal panel via optical transparent glue further comprises:
providing a bonding mechanism for compressing the backlight module and the display panel together;
arranging the display panel on a top late of the bonding mechanism;
arranging the backlight module on a down plate of the bonding mechanism;
distributing the optical transparent glue on one surface of the backlight module; and
compressing the top late and the down plate such that the backlight module is bonded with the optical transparent glue on the display panel.

4. The assembly method as claimed in claim 1, wherein the step of bonding at least one backlight module and a liquid crystal panel via optical transparent glue further comprises:
adopting a dispensing method to distribute the optical transparent glue on one surface of the backlight module;
arranging the display panel on the optical transparent glue to bond the display panel on the backlight module;
distributing the optical transparent glue between the backlight module and the display panel via self-leveling, heat leveling, or pressure-leveling; and
curing the optical transparent glue.

5. The assembly method as claimed in claim 1, wherein the step of bonding at least one backlight module and a liquid crystal panel via optical transparent glue further comprises:
coating the optical transparent glue on one surface of the backlight module;
arranging the display panel on the optical transparent glue to bond the display panel on the backlight module so as to form the display device; and
curing the optical transparent glue.

6. A display device, comprising:
a backlight module, optical transparent glue, and a display panel, bonding surfaces of the backlight module and the display panel are bonded together via the optical transparent glue.

7. The display device as claimed in claim 6, wherein the optical transparent glue is the optical transparent glue in a solid or a liquid state.

8. The display device as claimed in claim 6, wherein a thickness of the optical transparent glue 20 is in a range between 20 and 100 μm.

9. The display device as claimed in claim 6, wherein the backlight module and the display panel are compressed by a wheel bonding mechanism or a bonding mechanism having a vacuum chamber.

10. The display device as claimed in claim 6, wherein the backlight module compresses a light source, a frame, and a reflective sheet, a light guiding plate, a diffuser and an enhancement film arranged on the frame in sequence, and wherein the light source is arranged on one side of the light guiding plate, and the optical transparent glue is distributed on a top surface of the enhancement film.
